(19) United States
(12) Patent Application Publication
(10) Pub. No.: US 2021/0195120 A1
(43) Pub. Date: Jun. 24, 2021

(54) SYSTEMS AND METHODS FOR IMPLEMENTING SELECTIVE VISION FOR A CAMERA OR OPTICAL SENSOR

(71) Applicant: Lance M. KING, Henderson, NV (US)

(72) Inventor: Lance M. KING, Henderson, NV (US)

(21) Appl. No.: 17/127,470

(22) Filed: Dec. 18, 2020

Related U.S. Application Data
(60) Provisional application No. 62/950,701, filed on Dec. 19, 2019.

(51) Int. Cl. H04N 5/272; G06K 9/00; H04N 7/18

(52) U.S. Cl. CPC H04N 5/272; H04W 12/02; H04N 7/18; G06K 9/00288

(57) ABSTRACT

A system and method for implementing selective vision for a sensor, the method comprising: storing digital representations of one or more faces in a memory; receiving a selection of a level of privacy from among two or more levels of privacy related to a first face of the one or more faces; receiving a stream of video of an environment; identifying at least one face within the stream of video; comparing the at least one face with the digital representations of the one or more faces in the memory; identifying the first face from among the one or more faces; and substituting the first face within the video stream with a substitute graphical element.

### RELATED APPLICATION INFORMATION

This application claims priority under 35 U.S.C. § 119c to U.S. Provisional Application No. 62/950,701, filed on Dec. 19, 2019, which is incorporated herein by reference as if set forth in full.

### BACKGROUND INFORMATION

### 1. Technical Field

This disclosure relates to imaging systems. More specifically this disclosure relates to imaging systems in which selective vision can be implemented in order to obscure sensitive images, but still provide context and the ability to fully analyze the images.

### 2. Background

A modern digital camera can have an optical sensor and computer to process the sensor input. The sensor may or may not incorporate an Image Signal Process to perform some of the processing. For example, image signal processing can include white balance, contrast and brightness adjustment, auto focus, HDR (high dynamic range exposure), etc.

Every digital camera has at its heart a solid-state device which, like film, captures the light coming in through the lens to form an image. This device is called a sensor. There are a number of different cameras with differently-sized sensors. A sensor is a solid-state device which captures the light required to form a digital image. Each sensor can have millions of tiny wells known as pixels, and in each pixel there will be a light sensitive element, which can sense how many photons have arrived at that particular location. As the charge output from each location is proportional to the intensity of light falling onto it, it becomes possible to reproduce the scene as the photographer originally saw it—but a number of processes have to take place before this is all possible.

As the sensor is an analogue device, this charge first needs to be converted into a signal, which is amplified before it is converted into a digital form. So, an image may eventually appear as a collection of different objects and colors, but at a more basic level each pixel is simply given a number so that it can be understood by a computer.

As well as being an analogue device, a sensor is also colorblind. For the system to detect different colors, a mosaic of colored filters is placed over the sensor, with twice as many green filters as there are of each red and blue filters, to match the heightened sensitivity of the human visual system towards the color green. This system means that each pixel only receives color information for either red, green or blue—as such, the values for the other two colors are determined by a process known as demosaicing. An alternative to this system the Foveon sensor, which uses layers of silicon to absorb different wavelengths, the result being that each location receives full color information.

Conventionally, it was necessary to develop sensors with more and more pixels, as the earliest sensors were not sufficient for the demands of printing. That barrier was soon broken but sensors continued to be developed with a greater number of pixels, and compact sensors that once had two or three megapixels were soon replaced by the next generation of four of five megapixel variants. This has now escalated up to the 20MP compact cameras on the market today.

The sensors can include, for example, a charge-coupled device (CCD) sensor, a Complementary metal-oxide-semiconductor (CMOS) sensor, a Foveon X3 sensor, which is based on CMOS technology, or LiveMOS sensor.

The development and advancements of digital cameras has enabled myriad uses. The most obvious impact has been the inclusion of digital cameras in smart phones, which has transformed photography. But it has also, for example, enabled affordable home security and digital assistants that offer video surveillance. But such environments can be sensitive. While the home owner may want to surveil their home and detect intruders or emergencies, the home owner does not necessarily want to be captured in the video at all times.

Thus, for example, the home owner may not install cameras in certain areas of a home or building, e.g., in the bathroom or even bedroom, but that leaves gaps in the coverage, which can translate to gaps in security. There are other situations where one may want to obscure identities at least, or even any detail of people or objects in captured video.

### SUMMARY

Systems and methods for implementing selective vision in various applications that use optical sensors are described herein.

According to one aspect, a system and method for implementing selective vision for a sensor, the method comprises storing digital representations of one or more faces in a memory; receiving a selection of a level of privacy from among two or more levels of privacy related to a first face of the one or more faces; receiving a stream of video of an environment; identifying at least one face within the stream of video; comparing the at least one face with the digital representations of the one or more faces in the memory; identifying the first face from among the one or more faces; and substituting the first face within the video stream with a substitute graphical element.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 is a graphical representation of a system for providing selective vision in video capture;

FIG. 2 is a flowchart of a method for a method;

FIG. 3 is a flowchart of an embodiment of a method according to the disclosure;

FIG. 4 illustrates an example infrastructure, in which one or more of the processes described herein, may be implemented, according to an embodiment; and

FIG. 5 illustrates an application of the system illustrated in FIGS. 1-4.

### DETAILED DESCRIPTION

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

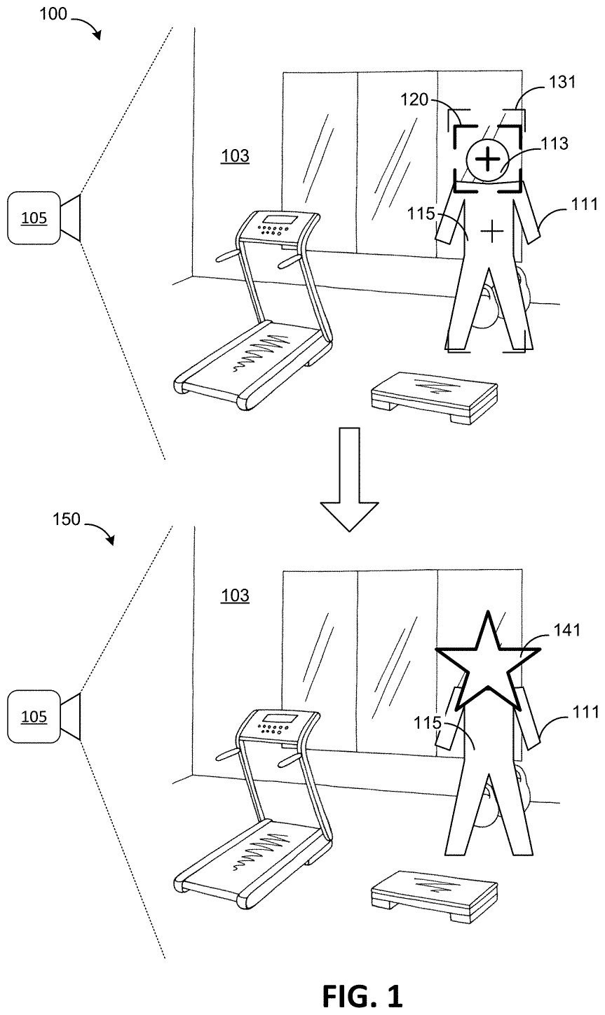

FIG. 1 is a graphical representation of a system for providing selective vision in video capture. In the embodiments described herein, a sensor or camera can provide selective vision or selective blindness to various aspects of a captured video scene or video sequence. In some examples, the sensor can selectively capture certain elements/objects. For example, sensors or cameras can be positioned at various areas throughout an environment, e.g., a house, to assist with home automation and security; however, the homeowner may also desire to maintain a level of privacy in certain areas of the house. The selective vision implemented by the disclosed systems and methods can identify specific portions, e.g., people or objects, within captured video using a bounding box or other graphical element to obscure, remove, or replace desired objects or people within the video.

In some implementations, the identified people or things can be replaced with a static graphic or image showing the person sitting, standing, or laying down, without actually showing moving video or images of the person in the images/sequence. In some examples, this can allow a home automation system to specifically avoid or replace identified people, e.g., via a whitelist or similar, that should not be shown or recorded in the video. This can prevent, for example, video being taken, e.g., recorded, of whitelisted individuals while taking a shower, or similar, while maintaining the security perimeter provided by the camera.

One or more sensors (sensor) 105 can be arranged to capture a scene 100 in an environment 103. The sensor 105 can be an optical sensor operable to capture images and video within the environment 103 in one or more spectra, including visible light, low light, infrared (IR), e.g., thermal imaging, and ultraviolet (UV) light, among others. The sensor 105 can further view the environment using various radiofrequency (RF) spectra, pulsed light imaging (PLI), and/or Light Detection and Ranging (LIDAR). Optical sensors are used as a primary example herein, but that is not limiting on the disclosure. Video, as used herein, can include a sequence of images, regardless of the medium or spectrum, visible, IR, UV, LIDAR, PLI, etc., in which the sequence of images is captured.

The environment 103 can include an indoor or outdoor space or wherever a camera can be mounted. The view of the environment 100 can be representative of a viewfinder of a security camera as shown by the dotted lines extending from the sensor 105, for example, in a gym. The view of the gym is not limiting on the disclosure, as any location can be used.

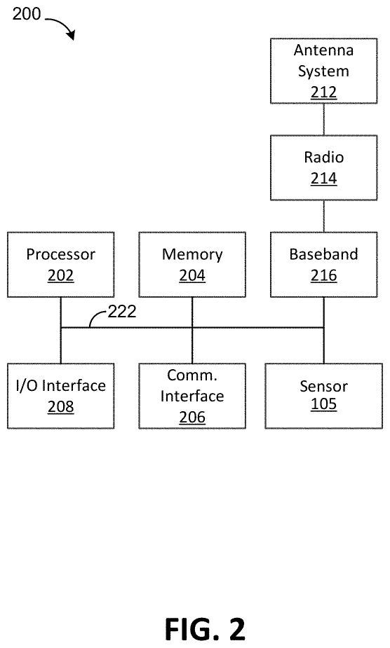

The scene 100 can have a person 111. The person can have a head, or face 113 and a body 115. A processor (FIG. 2) can receive and process the video, identifying one or more of the head/face 113 and the body 115. For example, the processor, using an automatic video tracker (AVT) 120 (or similar) can detect and track one or more faces (e.g., the face 113) within and throughout the scene 100 and associated video sequence/sequence of images. The processor can further track the entire body 115 of the person using an AVT 131. The person 111 is used as a primary example herein, but objects or things can be identified and tracked in a similar manner.

The systems and methods disclosed herein can identify and track the person 111 (e.g., via the AVTs 120, 131) and selectively replace the video of the tracked person 111 with another graphic 141 in a modified scene 150. In the exemplary implementation of FIG. 1, the face 113 of the person 111 can be replaced with the graphic 141. In some other implementations, the body 115 can also be replaced with the graphic 141. The graphic 141 is shown as a star, however this is an exemplary implementation.

In some embodiments, the video of the person 111, e.g., face 113 and/or body 115, can be blurred or otherwise obscured instead of replacing the video of the person 111 with the graphic 141.

In some embodiments, the sensor 105 can capture video of the environment 100 adjacent to the person 111 and replace video of the person 111 with video of the environment 100 modified scene 150, thereby eliminating the person 111 from the captured video entirely or otherwise rendering the person 111 invisible in the captured video of the modified scene 150.

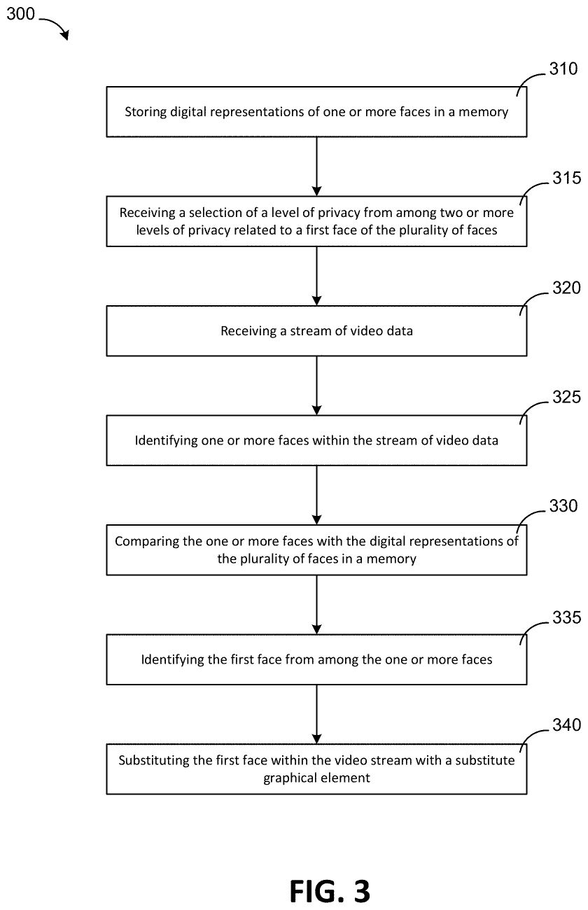

FIG. 3 is a flowchart of an embodiment of a method according to the disclosure. The system 200 and the processor 202 can be configured to perform a method 300.

At block 310, the processor can store digital representations of a one or more faces in the memory 204. The digital representations can include three dimensional models of selected faces and bodies (e.g., the face 113 and the body 115). The one or more faces can be, for example, the user's face 113, or other authorized faces included in the whitelist. Authorized faces can include images and other digital representations of the user's face or faces of friends and family, for example. The digital representations stored at block 310 can form a whitelist or list of people or faces registered with the system 200.

At block 315, the processor 202 can receive a selection of a level of privacy. The system 200 can implement one or more levels of privacy. The various levels of privacy can include varying levels in which the selected user's face 113/body 115, removed, obscured, or eliminated, for example. In some examples, a low level of security or privacy can include showing the person 110 in the video normally, or as the video is captured by the sensor 105. Higher levels of privacy can include substituting an image in for the selected user's face 113/body 115, blurring images/video of the selected user's face 113/body 115, or eliminating images/video of the selected user's face 113/body 115 within the video. The selection can be input by the user, for example.

The image of the user can be replaced with another image, icon, or graphic (e.g., the star of FIG. 1). In some implementations, the user's image can be blurred beyond recognition. In yet another implementation, the processor 202 can eliminate the user's image altogether and replace the image with a digital representation of the background of the video (e.g., the environment 100) copied from adjacent video frames.

At block 320, the processor 202 can receive a stream of video data from the sensor 105, including views of the environment 100, for example. The video stream can contain one or more figures, faces, bodies, etc. One or more people can appear within the video stream. The video and images can be associated with the sensors 105 implemented for security reasons.

At block 325, the processor 202 can identify one or more faces within the video stream. The processor 202 can implement one or more facial recognition processes to identify faces and bodies within the stream of video data.

At block 330, the processor 202 can compare the one or more identified faces with those stored within the memory 204 (e.g., in block 310). The processor 202 can implement various AI or ML to track aspect of the faces identified in the stream of video data and compare them to the three dimensional models stored within the memory 204.

At block 335, the processor 202 can determine that one or more face/body identified within the stream of video data is included in the whitelist, stored in the memory 204 at block 310.

At block 340, the processor can substitute the face 113 or the body 115 with another graphic or graphical element within the captured video. In some embodiments, the graphic 141 can be inserted over the person 111, as described above in connection with FIG. 1. In another implementation, the face 113 and the body 115 can be blurred beyond recognition. In another implementation, the face 113 and the body 115 can be replaced with imagery of the scene 100, thereby eliminating the person 111 from the captured video.

In another application of a system for providing selective vision in video capture, the sensor 105 can be installed within a bathroom, such is inside a mirror in order to ensure that employees and patrons are washing their hands sufficiently. The COVID-19 pandemic that is currently ruling the world, has changed the world forever. For example, the pandemic has made clear that hand washing is no longer optional. A United States Centers for Disease Control (CDC) study found only 65% of women and just 31% of men washed their hands after using the restroom. Another study showed roughly the same results for Europe where 60% of women and 28% of men wash their hands after using the restroom. This means a majority of people are NOT washing their hands after using the restroom, and the majority of those who wash don't do it correctly.

Clearly, placing a sign in the restroom reminding people to wash their hands is inadequate. But it's not just a matter of cleanliness, it's a matter of life and death. The CDC estimates there are 78 million cases of food-borne illness, requiring 325,000 hospitalizations and resulting in 5,000 deaths every year in the USA alone—and 34% of those are linked to poor hand hygiene. The global COVID-19 pandemic of 2020 with the many thousands of lives lost and economic cost in the trillions of dollars makes it clear every person and organization must make hand washing hygiene a priority. Revised regulations, fines, and increased insurance premiums will make proper hand hygiene a priority.

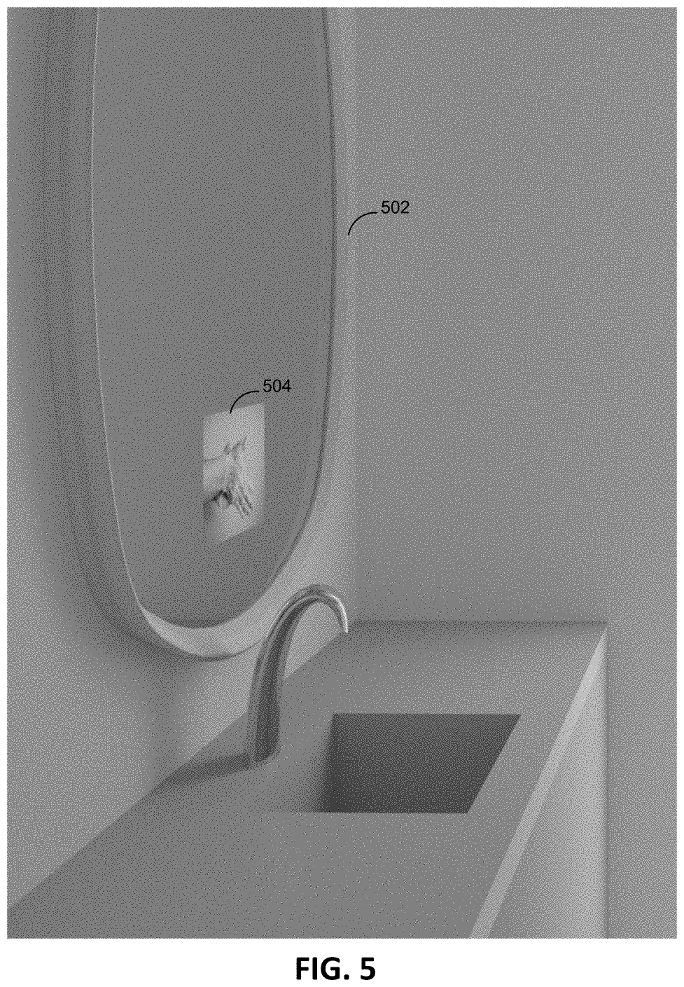

FIG. 5 illustrates such a clean hands application of the systems and methods described herein. A sensor 105 can be installed behind mirror 502 so that it can monitor individual swashing their hands. Of course, the selective vision/blindness, e.g., as described with respect to FIGS. 1 and 2, can be used to ensure that individuals are, e.g., only detected when washing their hands and that the individual is not identifiable. Of course, in this example, the system can be programmed to just block or obscure faces in general.

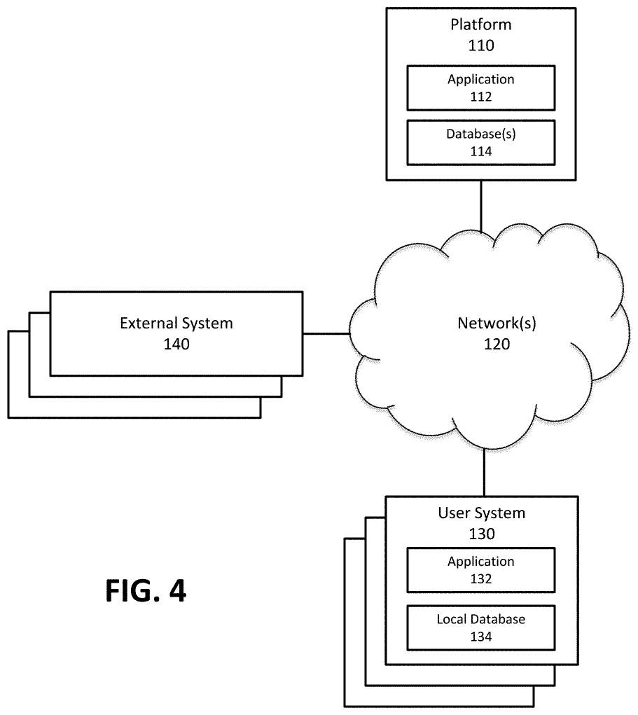

The system can also include a display screen 504 that can provide instructions and content to the individuals. It will be understood that the camera 105 and display 504 can be interfaced with a processing system such as disclosed in FIG. 2, which can host a platform 110 in FIG. 4.

Such an application can thus encourage proper and frequent hand washing by providing a comprehensive solution including: controlling the water flow to ensure perfect temperature water instantly, every time; automatically dispensing the perfect amount of, e.g., all-natural soap and moisturizers to gently cleanse the skin without causing chapping even with frequent washing; stopping water flow after soap is dispensed for an adjustable 10-20 seconds to provide time to wash and save water; a display 504 integrated into the mirror 502 provides proper washing instructions and status updates such as, “Soap in 3, 2, 1.” “Rinse begins in 15, 14, 13 . . . ; the display can optionally display time and date, weather, sports, news, or an interactive game to entertain while washing; can optionally provide a washing score to encourage improvement; can optionally track and verify that employees are complying with regulations to reduce insurance premiums; can optionally monitor soap use and provide alerts when it is time to order, or order automatically if desired and send a text message to maintenance when it is time to replace; and can optionally provide a visible and audible request to return to wash for people exiting without washing.

Thus, the systems and methods described herein can provide a comprehensive approach to hand hygiene that combines an advanced, sensor and AI (artificial intelligence) to accurately and intelligently monitor hand washing with complete privacy. Some key benefits can be continuous verification of compliance with hand washing policy to mitigate risk and reduce insurance premiums; verifying soap was used and hands washed for the prescribed amount of time; real-time, detailed analytics available; web-based analytics so there isn't any software to download or server to maintain; integrated display makes washing hands more entertaining and can even be used for digital signage to display weather, events, or advertisements; and automatic alerts/reminders when soap needs to be ordered and replaced.

FIG. 4 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™ PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

FIG. 2 is a functional block diagram illustrating an embodiment of a device for performing the methods disclosed herein. A system 200 can be used as or in conjunction with one or more of the sensors 105 (FIG. 1) or other platforms, devices or processes of the disclosure, and may represent components of devices, the corresponding backend server(s), and/or other devices described herein. The system 200 can be a server or any conventional personal computer, or any other processor-enabled device that is capable of wireless or wireline communication.

The system 200 can have one or more processors (processor) 202. The processor 202 can also be referred to as a central processing unit (CPU). Additional processors or microprocessors can be included, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, a graphics processing unit (GPU), neural processing unit (NPU), or a coprocessor. Such auxiliary processors may be discrete processors or may be integrated with the processor 202. The processor 202 can be configured to perform machine learning (ML) and artificial intelligence (AI) tasks.

The processor 202 can be communicatively coupled to a communication bus 222. The communication bus 222 may include a data channel for facilitating information transfer between storage and other peripheral components of the system 200. The communication bus 222 further may provide a set of signals used for communication with the processor 202, including a data bus, address bus, and control bus (not shown). The communication bus 222 can include any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

The system 200 can have a memory 204. The memory 204 provides storage of instructions and data for programs executing on the processor 202, such as one or more of the functions and/or modules discussed above. It should be understood that programs stored in the memory and executed by processor 202 may be written and/or compiled according to any suitable language, including without limitation C/C++, Java, JavaScript, Pearl, Visual Basic, .NET, and the like. The memory 204 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The memory 204 may optionally include an internal memory and/or a removable medium, for example a floppy disk drive, a magnetic tape drive, a compact disc (CD) drive, a digital versatile disc (DVD) drive, other optical drive, a flash memory drive, etc. The removable medium is read from and/or written to in a well-known manner. Removable storage medium 580 may be, for example, a floppy disk, magnetic tape, CD, DVD, SD card, etc.

The memory 204, including any removable storage medium can be a non-transitory computer-readable medium having stored thereon computer executable code (i.e., software) and/or data. The computer software or data stored on the removable storage medium is read into the system 200 for execution by the processor 202.

Other examples of memory 204 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media and communication interface 206, which allow software and data to be transferred from an external medium to the system 200.

System 200 may include a communication interface 206. The communication interface 206 allows software and data to be transferred between system 200 and external devices (e.g. printers), networks, or information sources. For example, computer software or executable code may be transferred to system 200 from a network server via communication interface 206. Examples of communication interface 206 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 200 with a network or another computing device.

The communication interface 206 can implement industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Computer executable code (i.e., computer programs or software) can be stored in the memory 204. Computer programs can also be received via the communication interface 206 and stored in the memory 204. Such computer programs, when executed, enable the system 200 to perform the various functions and methods described herein.

In this description, the term “computer readable medium” is used to refer to any non-transitory computer readable storage media used to provide computer executable code (e.g., software and computer programs) to the system 200. Examples of these media include memory 204, memory 204 and any peripheral device communicatively coupled with communication interface 206 (including a network information server or other network device). These non-transitory computer readable mediums are means for providing executable code, programming instructions, and software to the system 200.

In an embodiment that is implemented using software, the software may be stored on a computer readable medium and loaded into the system 200 by way of removable medium, an I/O interface 208, or the communication interface 206. The software, when executed by the processor 202, can cause the processor 202 to perform the methods and functions described herein.

The processor 202 can be communicatively coupled to the one or more sensors 105 via the communication bus 222 or the communication interface 206. Images and video can be captured via the sensor(s) 105 and stored in the memory 204. The processor can perform various tasks on the captured video and image data, as described below in connection with FIG. 3.

In an embodiment, the I/O interface 208 can provide an interface (e.g., a user interface) between one or more components of system 200 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 200 can include optional wireless communication components that facilitate wireless communication over a voice and over a data network. The wireless communication components comprise an antenna system 212, a radio system 214 and a baseband system 216. In the system 200, radio frequency (RF) signals are transmitted and received over the air by the antenna system 212 under the management of the radio system 214.

In one embodiment, the antenna system 212 may comprise one or more antennae and one or more multiplexors (not shown) that perform a switching function to provide the antenna system 212 with transmit and receive signal paths. In the receive path, received RF signals can be coupled from a multiplexor to a low noise amplifier (not shown) that amplifies the received RF signal and sends the amplified signal to the radio system 214.

In alternative embodiments, the radio system 214 may comprise one or more radios that are configured to communicate over various frequencies. In one embodiment, the radio system 214 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 214 to the baseband system 216.

If the received signal contains audio information, then baseband system 216 decodes the signal and converts it to an analog signal. Then the signal is amplified and sent to a speaker. The baseband system 216 also receives analog audio signals from a microphone. These analog audio signals are converted to digital signals and encoded by the baseband system 216. The baseband system 216 also codes the digital signals for transmission and generates a baseband transmit audio signal that is routed to the modulator portion of the radio system 214. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 212 where the signal is switched to the antenna port for transmission.

The baseband system 216 can be communicatively coupled with the processor 202 via the communications bus 222, for example. The processor 202 can have access to data storage areas of the memory 204. The processor 202 can be configured to execute instructions (i.e., computer programs or software) that can be stored in the memory 204 or the memory 204. Computer programs can also be received from the baseband processor 212 and stored in the data storage area 204 or in memory 204, or executed upon receipt. Such computer programs, when executed, enable the system 200 to perform the various functions of the present invention as previously described. For example, data storage areas 204 may include various software modules (not shown).

### Other Aspects

The accompanying claims and their equivalents are intended to cover such forms or modifications as would fall within the scope of the disclosure. The various components illustrated in the figures may be implemented as, for example, but not limited to, software and/or firmware on a processor or dedicated hardware. Also, the features and attributes of the specific example embodiments disclosed above may be combined in different ways to form additional embodiments, all of which fall within the scope of the disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, and algorithm operations described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects.

Thus, the claims are not intended to be limited to the aspects shown herein, but is to be accorded the full scope consistent with the language claims, wherein reference to an element in the singular is not intended to mean “one and only one” unless specifically so stated, but rather “one or more.”

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A system and method for implementing selective vision for a sensor, the method comprising:
storing digital representations of one or more faces in a memory;
receiving a selection of a level of privacy from among two or more levels of privacy related to a first face of the one or more faces;
receiving a stream of video of an environment;
identifying at least one face within the stream of video;
comparing the at least one face with the digital representations of the one or more faces in the memory;
identifying the first face from among the one or more faces; and
substituting the first face within the video stream with a substitute graphical element.

2. The system and method of claim 1, wherein the substitute graphical element comprises one of a static graphic, a blurred version of the first face, and a representation of the surrounding environment.
